(19) United States
(12) Patent Application Publication
(10) Pub. No.: US 2026/0078822 A1
(43) Pub. Date: Mar. 19, 2026

(54) SEALING RING ASSEMBLY WITH SPRING ELEMENT

(71) Applicant: Mainspring Energy, Inc., Menlo Park, CA (US)

(72) Inventors: Christopher Edward Wolfe, Niskayuna, NY (US); Nathaniel Oliver, Menlo Park, CA (US); Jeffrey Harris Mishler, San Francisco, CA (US); Matthew Svrcek, Redwood City, CA (US); Kevin Ting Chan, Oakland, CA (US); Arnab Jyoti Ghosh, San Jose, CA (US); Burak Yunus Cetin, Menlo Park, CA (US)

(21) Appl. No.: 19/328,903

(22) Filed: Sep. 15, 2025

Related U.S. Application Data
(60) Provisional application No. 63/695,282, filed on Sep. 16, 2024.

(51) Int. Cl. F16J 9/14

(52) U.S. Cl. CPC F16J 9/145

(57) ABSTRACT

A sealing ring assembly that includes a plurality of segments that forms a seal against a bore of a cylinder. Each pair of adjacent ring segments of the plurality of ring segments are coupled by a respective flexure therebetween. Each respective flexure causes a radially outward force to cause a respective radially outward surface of respective pairs of the adjacent ring segments to seal against a bore of a cylinder and a tangential force to be applied to the sealing ring assembly.

### CROSS-REFERENCE TO RELATED APPLICATIONS

This application claims the benefit of U.S. Provisional Patent Application No. 63/695,282 filed Sep. 16, 2024, the disclosure of which is hereby incorporated by reference herein in its entirety.

### FIELD OF THE DISCLOSURE

The present disclosure is directed towards a sealing ring assembly having one or more flexures (e.g., spring elements).

### BACKGROUND

Graphite rings are used to seal around pistons in applications where liquid lubricants are not used. In certain assemblies, the graphite rings may be segmented to avoid scenarios where relatively low strain to failure, that is inherent to graphite (e.g., as compared to other materials that may have more elastic responses to strain), results in higher levels of wear and physical failure of the rings before a preferred lifetime of use has been met or surpassed by the rings (e.g., number of cycles before mechanical failure). Pressure reversal caused by fluid exchange in a reaction section of a generator between intake and exhaust ports is known to collapse sealing rings towards a central axis as opposed to maintaining contact between a radially outward surface of the sealing rings and a bore against which the rings are configured to form a seal (e.g., a bore of a cylinder with a central axis along which a piston supported by gas bearings translates). In order to maintain the seal between the rings and the bore such that the rings remain seated (e.g., within a circumferential groove of the piston arranged axially behind a front land of the piston) through an operating cycle, segmented rings can be spring loaded against the cylinder wall to counteract pressure reversal.

Sealing rings may have different configurations depending on the heat profile that they are exposed to in an application. For example, a linear generator may have a low-temperature reaction application where sealing rings mounted on a piston are exposed to a low-temperature reaction such as from HCCI in a reaction cylinder. These “reaction cylinder” rings may be exposed to gases having at elevated temperatures (e.g., temperatures measurable as being multiples of three digit degrees Celsius up to multiples of four digits degrees Celsius). When a ring assembly is exposed to gases at these elevated temperatures for one or more operational cycles of the reaction cylinder, one or more segments of the ring assemblies can rise to a maximum temperature that is considered elevated as compared to an ambient temperature, depending on material composition of the segments. The linear generator may also have an air compression application (e.g., where a translator comprising a piston compresses gas provided to a gas spring chamber arranged on an opposite side of the translator from a reaction portion of a cylinder in which the translator and piston translator longitudinally) within the generator system. Sealing rings that are incorporated into a translator, or piston thereof, are exposed a lower temperature that sealing rings incorporated into the translator, or piston thereof, on a side of the translator exposed to the portion of the cylinder where reactions (e.g., as caused by compression of an air-fuel fixture) occur during operation of the linear generator. One or more segments of these “gas spring” rings can reach a maximum temperature less than the aforementioned “reaction cylinder” rings. Accordingly, the “gas spring” rings are not subjected to the same thermal deformation or material strain as the “reaction cylinder” rings.

Where sealing rings are installed for use in proximity to reaction portions of cylinders, these sealing rings that require design improvements to overcome issues that manifest over an operational lifetime of the sealing rings based on one or more of the intensity, the frequency, or the duration of reactions in the aforementioned reaction portions. For example, certain known approaches to developing a sealing ring assembly result in a fast wear rate when the sealing ring assembly is arranged for use during operation of a linear generator. Accordingly, these known approaches can result in an unacceptably short ring life as compared to a target duration for a sealing ring assembly arranged for using during operation of a linear generator. Although portions of material that is used to form segments of the sealing ring can be at least partially protected from conditions proximate to or caused by the reactions during operational cycles by applying a cover to portions of the ring segments, there remains an issue of subcomponents that connect segments being exposed to the harsh conditions generated as a result of the reactions as well as another issue of the materials that can be used to create the covers being subjected to material fatigue as a result of the harsh conditions resulting from reactions. The repeated reactions on the connecting subcomponents and the covers can result in an overall ring assembly operational life that is reduced as compared to a ring assembly without these components since these connecting components (e.g., including the covers) are typically made of materials different from graphite (e.g., a material often used for sealing rings in applications of this nature).

Another issue with certain sealing ring approaches where the sealing rings are arranged proximate to elevated temperature air-fuel reactions for an operational lifetime is related to the use of a beam spring to maintain contact between a sealing surface of a sealing ring assembly and a bore. The beam spring can be exposed to reaction temperatures because the spring is located external to material that forms segments of the sealing ring. Depending on the material selected for forming the beam spring, the aforementioned reaction temperatures can exceed limits of the selected material which can induce stress relaxation in the material of the beam spring which reduces the spring force that the beam spring is capable of producing over time, resulting in an accelerated service timeline and more downtime for servicing an assembly that uses the beam spring to assist with positioning of the beam spring. Preferably, a piston and a sealing ring assembly are developed to reduce fatigue in components, thereby reducing service intervals for the duration of operation of an assembly including the piston and the sealing ring.

The present disclosure is directed towards sealing ring assemblies including a plurality of segments that include features to reduce wear, reduce fracture risk, and reduce uneven wear in the absence of lubricating oil. A segmented ring with embedded flexures (e.g., spring elements, coil springs, coiled springs, spring assemblies, spring components, or combinations thereof suitable for the operating conditions described herein) pushing the segments apart and against the cylinder wall is a proposed solution to the different applications of a sealing ring. In some embodiments, one or more of the segments of the segmented ring assembly may comprise a wedge shaped layer, portion, or interface.

The respective flexures can be arranged or configured to apply force along a vector defined by a single axis (e.g., the force is applied in a straight line). As these respective flexures are embedded in a ring segment that may have a curved profile, the spring force pushing the segments apart can be considered to follow a tangential vector, thereby pushing the ring segments apart tangentially. For example, “tangentially” as used in reference to this disclosure may be considered a direction that is tangential to an associated azimuth (e.g., curved profile or shape) in one or more ring segments in which at least opposite ends of the respective flexure are arranged. The spring force results in a radially outward force that seats the ring segments. The respective flexures, therefore, are configured to apply a force to each ring segment interfacing with the respective flexures.

The force may be characterized by one or more vectors. In some embodiments, at least one vector characterizing the force corresponds to a radially outward force that causes the ring segments to form a seal against a wall of a cylinder bore. Additionally, or alternatively, the one or more vectors which may be used to characterize the force corresponds to an azimuthal component of the vector or an azimuthal component derived from a sum of vectors. As the springs shown in the figures herein are depicted as straight, these springs cause the force to be applied to the curved segments. In some embodiments, the springs used may be curved in order to generate a predominantly azimuthal force on the ring segments. In some embodiments, where a straight line defined, or corresponding, to a center line along an axial surface of a spring body is not correlated to the curved profile, or body, of the ring segments, then the force may be defined by vectors that are based off other aspects, features, or elements of the either the sealing ring assembly (e.g., based on an interface between segments) or a piston assembly (e.g., sides of a ring groove in which the sealing ring assembly is installed).

In reaction cylinder sealing ring applications, springs configured, or arranged, to press segments of a ring radially outward (e.g., along a vector where a straight force is applied along a curved body) are ideally kept below maximum operating temperature thresholds to avoid excessive stress relaxation which ultimately results in the material(s) comprising the spring to yield or deform mechanically. Maintaining the temperature of the ring structure below the maximum operating temperature threshold also enables application of an adequate seating force to the ring segments to maintain a position within an oscillating assembly (e.g., a linear electromagnetic machine) which prevents excessive wear and premature mechanical failure of the ring assembly. Applications include a piston exposed to a reaction (e.g., as in a linear electromagnetic machine with a reaction section configured to enable reactions of one or more fuel types) or other machines having a piston arranged to translate along a bore, where such machines require sealing between the piston and the bore (e.g., to assist with maintaining a barrier between pressurized regions axially arranged on opposite sides of the sealing interface). Beam (e.g., cantilever) springs attached to the piston and pushing radially outward on the ring segments have been considered as possible production implemented solutions.

For reaction cylinder applications, the respective flexures (e.g., springs) may be encompassed by the graphite segments by being inserted into holes in the graphite segments. This arrangement of the springs within the material comprising the segments maintains a temperature of the spring lower than temperatures throughout the assembly that are exposed to cylinder gas temperatures (e.g., effectively shielding the spring from a reaction section). In some implementations, the temperature of the graphite can be reduced by contact with the cylinder wall. The cylinder wall may be considered to function as a heat sink in the system (e.g., where the system is a generator that causes reactions of fuels to actuate a piston).

In gas spring applications similar considerations apply and certain implementations have employed various types of materials that are known to enable adequate seating and sealing solutions. Preferably, design approaches that minimize cost are desirable (e.g., maximizing effectiveness of material selection without having unnecessary features or components). In reaction cylinder applications, such as on a piston exposed to a reaction, this challenge has been addressed with beam springs attached to the piston and pushing radially on the ring segments (e.g., as described in U.S. Pat. No. 11,873,906 filed Nov. 17, 2021 and issued on Jan. 16, 2024, which claims priority to U.S. Provisional Ser. No. 63/115,248 filed Nov. 18, 2020).

Pins may be installed through the springs (e.g., through the centers of the springs) to provide structural support, provide a guide, and for vibration attenuation for the springs during the accelerations of the piston. The pins may also be arranged within a sealing ring assembly to provide a contact surface for an adjacent segment. It should be noted that this approach to outward biasing the ring segments lends itself to the easy and inexpensive replacement of pins and springs at the same time as the rings themselves. Current beam spring approaches do not enable such ease of service of components because a beam spring is typically attached to the piston and therefore requires substantially more teardown to access parts for replacement.

In some embodiments, the present disclosure is directed to a sealing ring assembly that includes a plurality of ring segments. Each pair of adjacent ring segments of the plurality of ring segments are coupled by a respective flexure therebetween. Each respective flexure causes a radially outward force to cause a respective radially outward surface of respective pairs of the adjacent ring segments to seal against a bore of a cylinder and a tangential force to be applied on the sealing ring assembly.

In some embodiments, each respective flexure is embedded at least partially in each respective ring segment of a respective pair of adjacent ring segments. Additionally, or alternatively, each respective flexure is entirely encompassed by material comprising a respective pair of adjacent ring segments.

In some embodiments, one ring segment of at least one of the pairs of adjacent ring segments is a wedge-shaped ring segment. One side of a respective flexure is arranged in a notch of the wedge-shaped ring segment.

In some embodiments, at least one of the respective flexures comprises a compression spring that accommodates a pin. Additionally, or alternatively, the pin comprises a rounded head for aligning the pin with a notch in a ring segment of the at least one of the pairs of adjacent ring segments.

In some embodiments, the sealing ring assembly is configured for oil-less operation.

In some embodiments, a ring segment of each of the pairs of adjacent ring segments comprises a blind hole for accommodating each respective flexure.

In some embodiments, at least one ring segment of the plurality of ring segments comprises one or more of a chamfered surface or a rounded surface. A surface area of the one or more of the chamfered surface or the rounded surface is less than a surface area of a respective radially outward surface of the at least one ring segment.

In some embodiments, each respective flexure is arranged such that it is axially offset from an axial center of each sealing ring segment of a respective pair of adjacent sealing ring segments between which it is arranged. Additionally, or alternatively, the axial offset positions each respective flexure such that each respective flexure is biased towards an outer surface of each of each sealing ring segment of a respective pair of adjacent sealing ring segments.

In some embodiments, the disclosure is directed to a device that includes a cylinder comprising a bore and a sealing ring assembly. The sealing ring assembly is configured to seal against the bore and arranged in a circumferential groove of a translator assembly to actuate within the cylinder, the sealing ring assembly comprises a plurality of ring segments. In some embodiments, each pair of adjacent ring segments of the plurality of ring segments are coupled to a respective flexure therebetween. Additionally, or alternatively, each respective flexure causes a radially outward force to cause a radially outward surface of respective pairs of the adjacent ring segments to seal against the bore and a tangential force to be applied on the sealing ring assembly.

In some embodiments, the disclosure is directed to a sealing ring assembly with at least one flexure a plurality of ring segments. At least one ring segment of the plurality of ring segments includes a radially outward sealing surface that at least partially defines a circle and a blind hole extending along a chord of the circle. A flexure of the at least one flexure is arranged in the blind hole. The at least one flexure interfaces with at least one other ring segment of the plurality of ring segments. The at least one other ring segment is adjacent to the at least one ring segment. In some embodiments, the respective flexure generates a respective force along the respective chord. Additionally, or alternatively, the respective force includes a radially outward force (e.g., to cause a respective radially outward surface of respective pairs of adjacent ring segments of the plurality of ring segments to seal against a bore of a cylinder) and a tangential force (e.g., to be applied on the sealing ring assembly).

In some embodiments, the at least one other ring segment comprises a notch that accommodates a portion of at least one of the at least one flexure or at least one flexure assembly. In some embodiments, the at least one flexure, or the at least one flexure assembly, comprises spring. Additionally, or alternatively, the spring may be a coiled spring.

In some embodiments, the sealing ring assembly includes a pin arranged along a length of a coiled spring. Additionally, or alternatively, the pin may include a rounded head for engaging the pin with a notch of the at least one other ring segment.

In some embodiments, an opening of the blind hole is offset toward an axial end of the at least one ring segment. Additionally, or alternatively, the blind hole extends into the at least one ring segment parallel to a surface profile of a wedge shaped surface of the at least one other ring segment.

In some embodiments, the disclosure is directed to a sealing ring assembly that includes a plurality of ring segments. Each pair of adjacent ring segments of the plurality of ring segments are coupled by a respective flexure therebetween. Additionally, or alternatively, each respective flexure causes a radially outward force (e.g., to cause a respective radially outward surface of the respective pairs of the adjacent ring segments to seal against a bore of a cylinder) and a tangential force (e.g., to be applied on the sealing ring assembly).

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 illustrates an angled view of an example sealing ring assembly, in accordance with some embodiments of the disclosure;

FIG. 2 illustrates an example pair of flexures and pin that are each embedded in example adjacent sealing ring segments, in accordance with some embodiments of the disclosure;

FIG. 3A illustrates an example wedge-shaped sealing ring segment arranged between other example sealing ring segments, in accordance with some embodiments of the disclosure;

FIG. 3B illustrates the assembly of FIG. 3A with material removed from an example axial surface to expose an example pair of embedded flexures and pins, in accordance with some embodiments of the disclosure;

FIG. 4A illustrates an example exposed end of flexure and pin embedded in an example sealing ring segment, in accordance with some embodiments of the disclosure;

FIG. 4B illustrates an example portion of coils and an example pin body of a flexure and pin embedded in example adjacent sealing ring segments, in accordance with some embodiments of the disclosure;

FIG. 5 illustrates an example sealing ring segment with reduced radially inward surface area relative to a radially outward surface area, in accordance with some embodiments of the disclosure;

FIG. 6 illustrates an example sealing ring arrangement with example tangentially sprung pairs of adjacent ring segments with illustrative force vectors, in accordance with some embodiments of the disclosure;

FIG. 7 illustrates an example sealing ring arrangement with example chords, in accordance with some embodiments of the disclosure; and

FIG. 8 illustrates a cross section view of an example illustrative generator including two piston assemblies that each include sealing ring assemblies, in accordance with some embodiments of the disclosure.

### DETAILED DESCRIPTION

The present disclosure is directed towards piston sealing ring assemblies, and more particularly the present disclosure is directed towards segmented sealing rings that include features to reduce wear, reduce fracture risk, and reduce uneven wear in the absence of lubricating oil. A segmented ring with embedded respective flexures pushing the segments apart and against the cylinder wall is a proposed solution to the different applications of a sealing ring. In some embodiments, one or more of the segments of the segmented ring assembly may comprise a wedge shaped layer, portion, or interface.

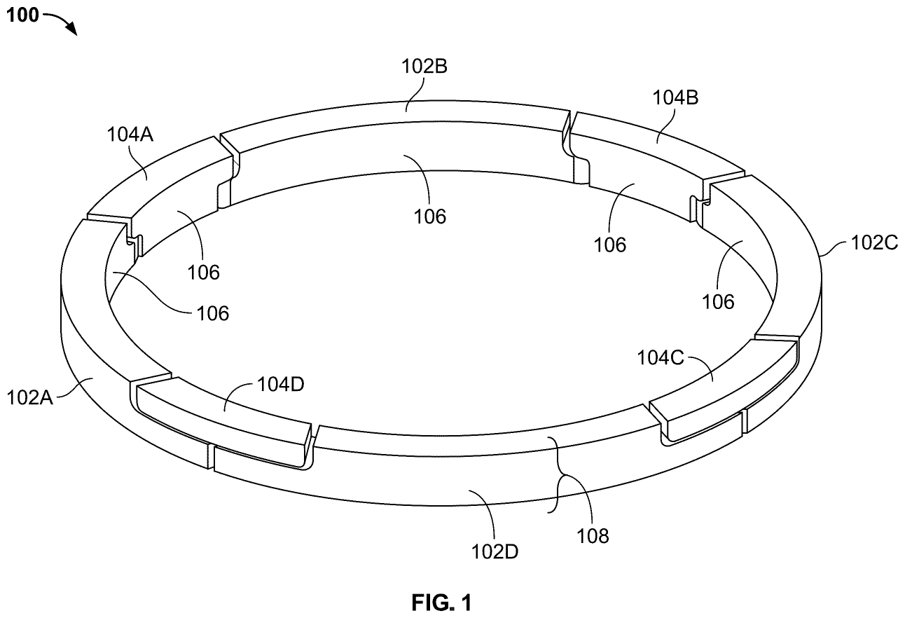

FIG. 1 shows sealing ring assembly 100, in accordance with some embodiments of the disclosure. Sealing ring assembly 100 is comprised of sealing ring segments 102A-D and wedge-shaped sealing ring segments 104A-D. Each of wedge-shaped sealing ring segments 104A-D are arranged between respective pairs of sealing ring segments 102A-D. For example, wedge-shaped sealing ring segment 104A is shown in FIG. 1 as being arranged between sealing ring segments 102A and 102B. Wedge-shape sealing ring segment 104B is shown in FIG. 1 as being arranged between sealing ring segments 102B and 102C. Wedge-shaped sealing ring segment 104C is shown in FIG. 1 as being arranged between sealing ring segments 102C and 102D. Wedge-shaped sealing ring segment 104D is shown in FIG. 1 as being arranged between sealing ring segments 102A and 102D. Collectively, sealing ring segments 102A-D and wedge-shaped sealing ring segments 104A-D form radially inward surface 106 of sealing ring assembly 100 and radially outward surface 108 of sealing ring assembly 100. Radially outward surface 108 can be arranged in a device so as to form a seal against a bore when segments of sealing ring assembly 100 are pressed radially outwards (e.g., based at least in part on a pressure differential between a pressurized region contacting radially outward surface 108 and a pressurized region contacting radially inward surface 106).

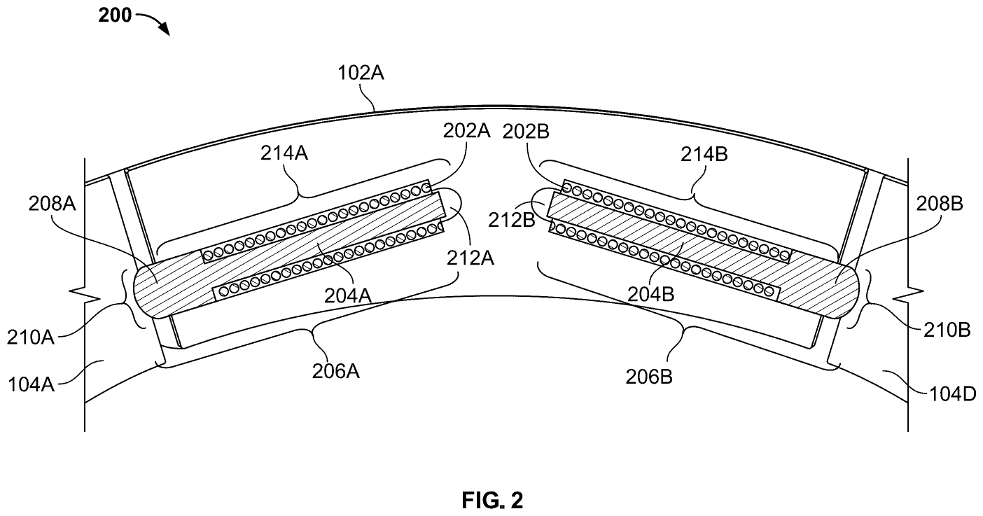

FIG. 2 shows example sealing ring assembly 200 including flexures 202A and 202B arranged around pins 204A and 204B, respectively, such that each of pinned spring assemblies 206A and 206B are embedded in sealing ring segment 102A while being accommodated by wedge-shaped sealing ring segments 104A and 104D, respectively, in accordance with some embodiments of the disclosure. It should be understood that the relative sizing of the components shown in FIG. 2, and described in reference to the various elements thereof, is illustrative for clarity with respect to how these components interface and should not be considered literal, or limiting, representations of the components described herein. In some embodiments, sealing ring assembly 200 can be considered suitable for use in a device including a power cylinder that uses reactions to actuate a translator assembly, including a groove for accommodating sealing ring assembly 200, along a bore of a cylinder. As shown in FIG. 2, each of pinned spring assemblies 206A and 206B are at least partially embedded in sealing ring segment 102A. Although wedge-shaped sealing ring segments 104A and 104D are shown in FIG. 2 as interfacing with sealing ring segment 102A, any combination of wedge-shaped sealing ring segments 104A-D can be paired with one or more of sealing ring segments 102A-D in order to achieve the arrangement shown as sealing ring assembly 200 of FIG. 2.

Pinned spring assembly 206A also includes rounded head 208A while pinned spring assembly 206B includes rounded head 208B. In some embodiments, one or more of rounded head 208A or 208B comprises a different geometry than what is shown in FIG. 2 (e.g., instead of a rounded geometry, one or more of these heads can be a cone, a cylinder, a cube, or any other suitable geometry for being received by one or more of wedge-shaped sealing ring segments 104A or 104D). Rounded head 208A is received, or accommodated by, notch 210A of wedge-shaped sealing ring segment 104A. Notch 210A aligns pin 204A with wedge-shaped sealing ring assembly 104A, which is adjacent to sealing ring assembly 102A on a first side. Rounded head 208B is received, or accommodated by, notch 210B of wedge-shaped sealing ring segment 104D. Notch 210B aligns pin 204B with wedge-shaped sealing ring assembly 104D, which is adjacent to sealing ring assembly 102A on a second side opposite the first side. Flexure 202A is arranged around pin 204A and extends from rounded head 208A towards end 212A of blind hole 214A of sealing ring segment 102A. Flexure 202B is arranged around pin 204B and extends from rounded head 208B towards end 212B of blind hole 214B of sealing ring segment 102A.

As shown in FIG. 2, blind holes 214A and 214B are each depicted with respective steps that narrow each of blind holds 214A and 214B from a larger diameter for accommodating flexures 202A and 202B, respectively to a smaller diameter for accommodating pins 204A and 204B, respectively. The smaller diameter is show towards, or at, a depth (e.g., bottom surface) of each of blind holes 214A and 214B, respectively, and is after an end of the larger diameter for accommodating flexures 202A and 202B, respectively. As shown in FIG. 2, respective lips are formed (e.g., out of graphite used to form sealing ring segment 102A) at the transition from the larger diameter to the smaller diameter such that ends of flexures 202A and 202B push against the respective formed lips in blind holes 214A and 214B. In some embodiments, rounded heads 208A and 208B may be configured to move axially out of blind holes 214A and 214B, respectively, as sealing ring segment 102A wears (e.g., according to friction experienced by a radially outward surface of sealing ring segment 102A causing material of the radially outward surface to wear away). Additionally, or alternatively, flexures 202A and 202B may expand responsive to the wear thereby causing rounded headed 208A and 208B to protrude from axial ends of blind holes 214A and 214B, respectively. The depicted smaller diameters of blind holes 214A and 214B extend into sealing ring segment 102A to respective depths that may, in some embodiments, enable respective ends of pins 204A and 204B to structurally support flexures 202A and 202B, respectively, for a target operational lifetime of sealing ring assembly 200.

Flexures 202A and 202B may, in some embodiments, be exposed to elevated temperatures relative to an ambient temperature (e.g., temperatures that are multiples of three digits in degrees Celsius) when installed in a sealing ring assembly that is arranged in a groove of a reciprocating device. Flexures 202A and 202B may, in some embodiments, assist with causing the sealing ring assembly to form a seal against a bore of cylinder in which the reciprocating device translates. To ensure each of flexures 202A and 202B can retain preferred material characteristics for the duration of a target operational lifecycle, material selection for flexures 202A and 202B is imperative to the ability of flexures 202A and 202B to assist with causing segments of the sealing ring assembly to form the seal against the bore. Ideal candidate materials for these operating conditions include one or more of Elgiloy (a registered trademark of Elgiloy Special Metals) materials (e.g., alloys with combinations of one or more of cobalt, chromium, nickel, molybdenum, iron, manganese, or carbon), super-alloys (e.g., combinations of metals that operate for a target lifetime closer to a melting point of a respective alloy than an ambient temperature), Rene 41, or alloy X-750.

Pins 204A and 204B are subjected to axial acceleration when installed in sealing ring assembly arranged in a groove of a reciprocating device to assist with causing the sealing ring assembly to form a seal against a bore of cylinder in which the reciprocating device translates. This axial acceleration causes contact between one or more of pins 204A or 204B and material of the sealing ring segments of this disclosure. To ensure pins 204A and 204B can withstand the contact resulting from this axial acceleration, pins 204A and 204B may be formed of at least one material, such as one or more steel alloys incorporating one or more of chromium or nickel (e.g., Incoloy which is considered a super-alloy identifier registered as a trademark of Special Metal Corporation). Incoloy materials provide pins 204A and 204B with resistance to corrosion and material durability in an elevated temperature environment (e.g., as described herein) so as to ensure pins 204A and 204B can maintain material integrity and function for the duration of a target operational lifecycle while being exposed to the elevated temperature environment.

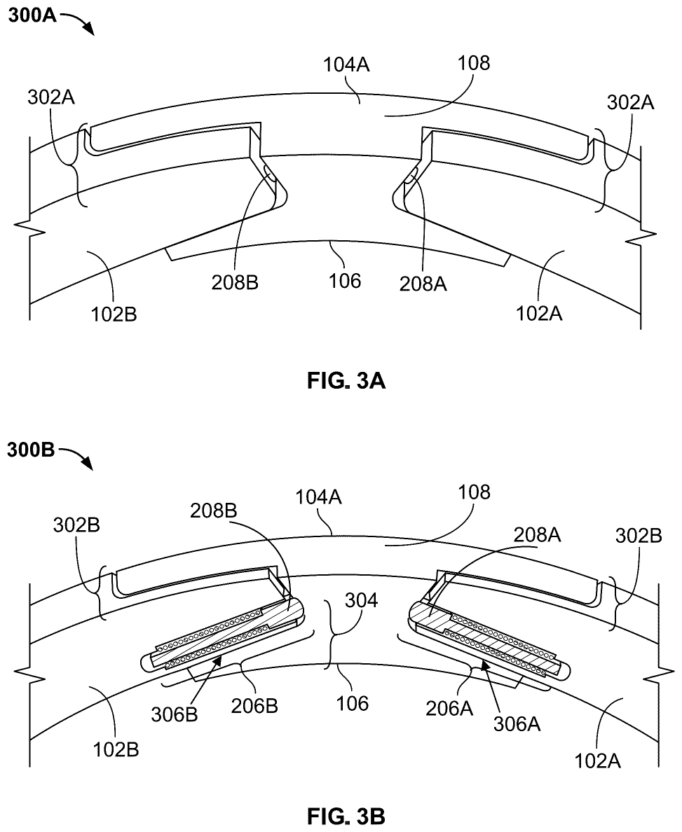

FIG. 3A shows example adjacent sealing ring segments 300A, in accordance with some embodiments of the disclosure. Adjacent sealing ring segments 300A include sealing ring segments 102A and 102B arranged on either side of wedge-shaped sealing ring segment 104A. Adjacent sealing ring segments 300A are shown with material thickness 302A such that embedded components (e.g., flexures such as coiled springs) are embedded in the sealing ring segments and, therefore, are not exposed to conditions of an environment surrounding adjacent sealing ring segments 300A. In some embodiments, embedded flexures, or flexure assemblies, may be axially offset within adjacent sealing ring segments 300A such that the embedded flexures, or flexure assemblies, are displaced from at least one of an axial side or a radial side of adjacent sealing ring segments 300A that is subjected to contact from reaction gasses (e.g., gasses at elevated temperatures relative to an ambient temperature) during operation such that the embedded flexures, or flexure assemblies, maintain a relatively cooler temperature for an operational lifetime (e.g., as compared to be directly exposed to, or directly contacted, by the reaction gasses).

Between sealing ring segment 102B and wedge-shaped sealing ring segment 104A is rounded head 208B, which is received by a notch in wedge-shaped sealing ring segment 104A. Between sealing ring segment 102A and wedge-shaped sealing ring segment 104A is rounded head 208A, which is received by a notch, different from the notch that receives rounded head 208B, in wedge-shaped sealing ring segment 104A. As shown in FIGS. 3A and 3B, rounded heads 208A and 208B are, in some embodiments positioned within adjacent sealing ring segments 300A to be closer to radially outward surface 108 than radially inward surface 106.

FIG. 3B shows example cutaway adjacent sealing ring segments 300B, which correspond to the assembly of FIG. 3A with material removed from an axial surface to expose a pair of embedded flexures and pins, in accordance with some embodiments of the disclosure. Cutaway adjacent sealing ring segments 300B include reduced material thickness 302B, which is less than material thickness 302A of FIG. 3A as FIG. 3B is, in some embodiments, a cutaway view of sealing ring segments 300 A of FIG. 3A. Based on the removal of material from the sealing segments, pinned spring assemblies 206A and 206B are visible. Pinned spring assemblies 206A and 206B comprise rounded heads 208A and 208B, respectively, and are displaced from radially inward surface 106 by distance 304 to reduce an amount of heat that pinned spring assemblies 206A and 206B are, in some embodiments, exposed to during operation of a device that incorporates a sealing ring assembly comprised of adjacent sealing ring segments including pinned spring assemblies 206A and 206B.

In some embodiments, pinned spring assembly 206A may be axially aligned parallel to sliding interface 306A between wedge-shaped sealing ring segment 104A and sealing ring segment 102A. Additionally, or alternatively, pinned spring assembly 206B may be axially aligned parallel to sliding interface 306B between wedge-shaped sealing ring segment 104A and sealing ring segment 102B. For example, a force applied by a respective spring of pinned spring assemblies 206A or 206B remains substantially parallel to sliding interface 306A or 306B, respectively, as radially outward surface 108 is subjected to wear. Wearing of the material comprising radially outward surface 108 causes, in some embodiments, respective springs of pinned spring assembly 206A and 206B to expand within respective blind holes such that rounded heads 206A and 206B press against wedge-shaped sealing ring segment 104A as each of sealing ring segments 102A and 102B slide along sliding interfaces 306A and 306B, respectively (e.g., becoming radially displaced so as to expose more of wedge-shaped sealing ring segment 104A as radially outward surface 108 wears or loses material due to friction between radially outward surface 108 and a bore of a cylinder).

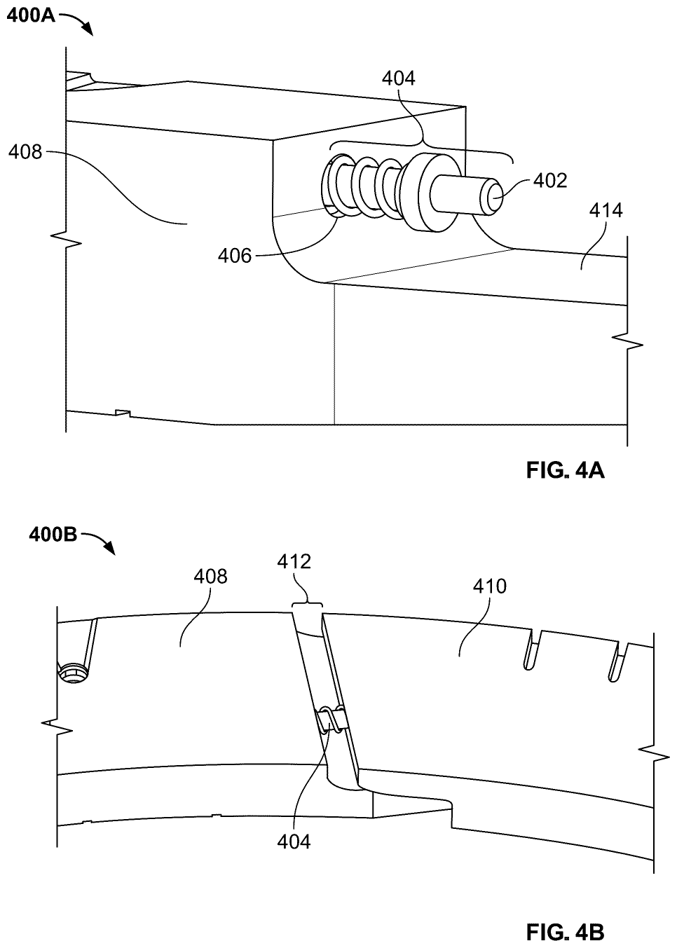

FIG. 4A depicts example sealing ring subassembly 400A with exposed end 402 of pinned flexure assembly 404 (e.g., a pinned coiled spring assembly), which extends into blind hole 406 of sealing ring segment 408, in accordance with some embodiments of the disclosure. Sealing ring subassembly 400A is an example of a sealing ring segment with a pinned spring arrangement that is suitable for use in a device requiring a sealing ring assembly for sealing against a bore of a cylinder, where the cylinder includes a volume for pressurizing an air spring. Exposed end 402 protrudes from the portion of pinned flexure assembly 404 that remains external to blind hole 406 of sealing ring segment 408. Exposed end 402 is configured to interface with a second sealing ring segment, different from sealing ring segment 408, that would be arranged to at least partially contact ring segment surface 414.

FIG. 4B depicts example sealing ring assembly 400B with coils of pinned flexure assembly 404 being exposed between adjacent sealing ring segments, in accordance with some embodiments of the disclosure. Sealing ring segment 408 of FIG. 4A includes pinned flexure assembly 404, which is received into sealing ring segment 410. Sealing ring segment 410 is arranged over a portion of sealing ring segment 408 (e.g., the portion corresponding to ring segment surface 414 of FIG. 4A). Between ends of sealing ring segment 408 and sealing ring segment 410 is gap 412, which allows sealing ring segments 408 and 410 to be compressed towards radial ends of each other for insertion into a cylinder (e.g., after being installed in a circumferential groove of a piston to at least partially form a piston assembly for translating along a bore of the cylinder). Gap 412 exposes a portion of pinned flexure assembly 404 such that one or more coils of pinned flexure assembly 404 are exposed to conditions of an environment in which sealing ring assembly 400B is arranged.

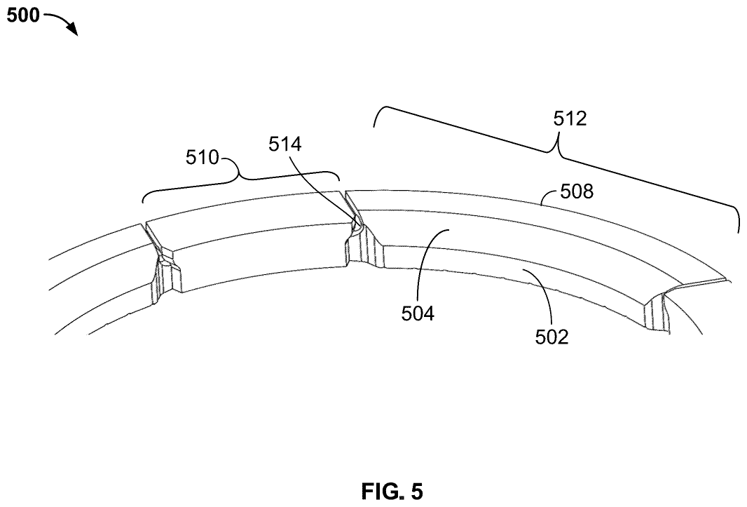

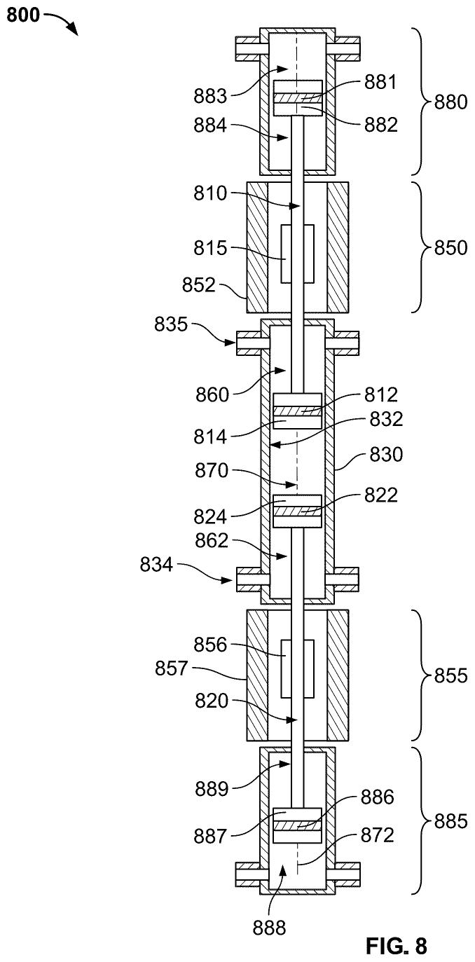

FIG. 5 depicts example sealing ring subassembly 500 including sealing ring segment 510 and sealing ring segment 512 that includes a reduced surface area, in accordance with some embodiments of the disclosure. Sealing ring segment 510 can, in some embodiments, be considered a portion of a wedge-shaped sealing ring segment and interfaces with a portion of sealing ring segment 512. Sealing ring subassembly 500 may be installed in a device having a translator assembly that relies on reaction to actuate the translator assembly along a bore of a cylinder (e.g., generator 800 of FIG. 8). Additionally, or alternatively, a pressure may be generated based on a reaction in a reaction section of the cylinder which, in some embodiments, causes a force to be applied to at least radially inward surface 502 of sealing ring segment 512 such that at least sealing ring segment 512 moves radially outward causing radially outward surface 508 to contact the aforementioned bore. In some embodiments, and as shown in FIG. 5, notch 514 is embedded in a side surface of sealing ring segment 512 (e.g., a radial surface arranged to face an opposing radial surface of sealing ring segment 510). Notch 514 may, in some embodiments, be configured to receive a rounded head of a flexure assembly or a pin of a flexure assembly.

Radially outward surface 508 of sealing ring segment 512 is arranged on an opposite radial side of sealing ring segment from radially inward surface 502. Radially outward surface 508 comprises, in some embodiments, a surface area suitable to provide a contact area for forming a seal (e.g., against the aforementioned bore of the cylinder). The temperature of a bore of a cylinder that, in some embodiments, contacts radially outward surface 508 may be lower than a temperature of reaction gases generated from a reaction section of the cylinder. These reaction gases may, in some embodiments, contact radially inward surface 502 to push sealing ring segment against the bore of the cylinder to form a seal. Additionally, or alternatively, heat may propagate from the reaction gases to radially inward surface 502 radially outward through a main body of sealing ring segment 512 along radially outward surface 508 to be transferred to the bore of the cylinder.

By reducing an area of radially inward surface 502 relative to an area of radially outward surface 508, an amount of surface area of sealing ring subassembly 500 directly exposed to reaction gases is reduced (e.g., where heat transfer is proportional to contact area). This relative reduction of surface area may, in some embodiments, reduce (e.g., at least proportionally) a temperature of sealing ring subassembly 500 through an operational lifetime relative to a version of the subassembly that lacks this difference in surface area between radially outward and radially inward surfaces. In some embodiments, this reduced temperature exposure of the operational lifetime of the subassembly may decrease a wear rate over the operational lifetime of the subassembly associated with radially outward surface 508. In some embodiments, radially inward edge 504 of sealing ring segment 512 includes a chamfer (e.g., as shown in FIG. 5). Additionally, or alternatively, radially inward edge 504 may include one or more of filleting or varying degrees of chamfering to reduce a surface area of at least one of radially inward surface 502 or the depicted axial surface of sealing ring segment 512. Accordingly, incorporation of these features may, in some embodiments, reduce heat transferred at least radially through a main body of sealing ring segment 512 towards radially outward surface 508.

In some embodiments, the described prevention, or reduction, of heat propagation through sealing ring segment 512 may reduce the temperature over an operational lifetime of embedded springs and pins (e.g., as described at least in reference to FIGS. 2-4B) within segments of sealing ring subassembly 500, thereby decreasing an amplitude of thermal cycling of sealing ring segments and embedded components thereof thereby delaying eventual material fatigue of these pins and springs. This may, in some embodiments, enable spring assemblies to maintain their respective abilities to provide enough spring force on adjacent sealing ring segments for biasing at least radially outward surfaces of the adjacent sealing ring segments against a cylinder wall (e.g., a bore of a cylinder). In some embodiments, a translator assembly including the described sealing ring segments and embedded components may cause the sealing ring segments to be subjected to pressure reversal as the translator assembly propagates along a cylinder bore away from a reaction section (e.g., a high pressure region). Additionally, or alternatively, the described embedded pins and springs (e.g., flexure assemblies) assist with forcing the ring segments to maintain contact with the cylinder bore when exposed to the mentioned pressure reversal.

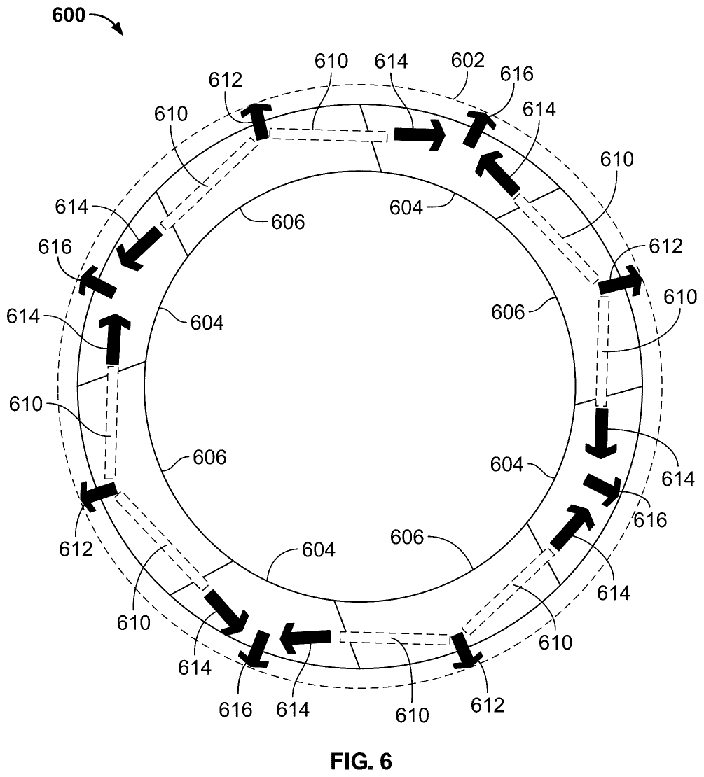

FIG. 6 depicts example sealing ring arrangement 600 including tangentially sprung pairs of adjacent ring segments with illustrative force vectors, in accordance with some embodiments of the disclosure. Sealing ring arrangement 600 depicts a sealing ring assembly that is comprised of sealing ring segments 606 and wedge-shaped sealing ring segments 604 arranged within cylinder bore 602. The sealing ring assembly is configured to expand radially outward to contact cylinder bore 602 and form a seal based at least in part on radially outward force. The radially outward force can, in some embodiments, be generated based on a reaction in a portion of the cylinder. On either side of each of wedge-shaped sealing ring segments 604 are respective sealing ring segments 606. Embedded in each of sealing ring segments 606 are tangential spring assemblies 610 (e.g., corresponding to pinned spring assemblies 206A and 206B of FIG. 2). Based on the arrangement of tangential spring assemblies 610, tangential force vectors 614 cause wedge-shaped sealing ring segments 604 to propagate radially outwards towards cylinder bore 602. Radial force vectors 616 are shown as causing sealing ring segments 604 to propagate radially outwards towards cylinder bore 602. Radial force vectors 616 may, in some embodiments, be a portion of tangential force vectors 614 or a resultant of opposing tangential force vectors 614. Additionally, the depicted arrangement of tangential spring assemblies 610 results in radial force vectors 612 causing sealing ring segments 606 to propagate radially outwards towards cylinder bore 602. While springs can be used for azimuthal mobility of ring segments for other use cases, the tangential springs of this disclosure are used for a different purpose in order to result in a radially outward movement of ring segments to result in sealing of a radially outward surface of the ring segments against a bore (e.g., resulting in flat surface to flat surface sealing). In some embodiments, tangential spring assemblies 610 may be arranged collectively or independently at various azimuthal angles different from the azimuthal arrangements depicted in FIG. 6. Additionally, or alternatively, the arrangement of any or all of tangential spring assemblies 610 according to any azimuthal angle may provide an adequate azimuthal adjustment or translation of any or all of sealing ring segments 606 or wedge-shaped sealing ring segments 604 so as to cause any or all of these ring segments to be biases radially outwards (e.g., towards cylinder bore 602). In some embodiments, any or all of tangential spring assemblies 610 are arranged parallel to one of sliding interfaces 306A or 306 B of FIG. 3B.

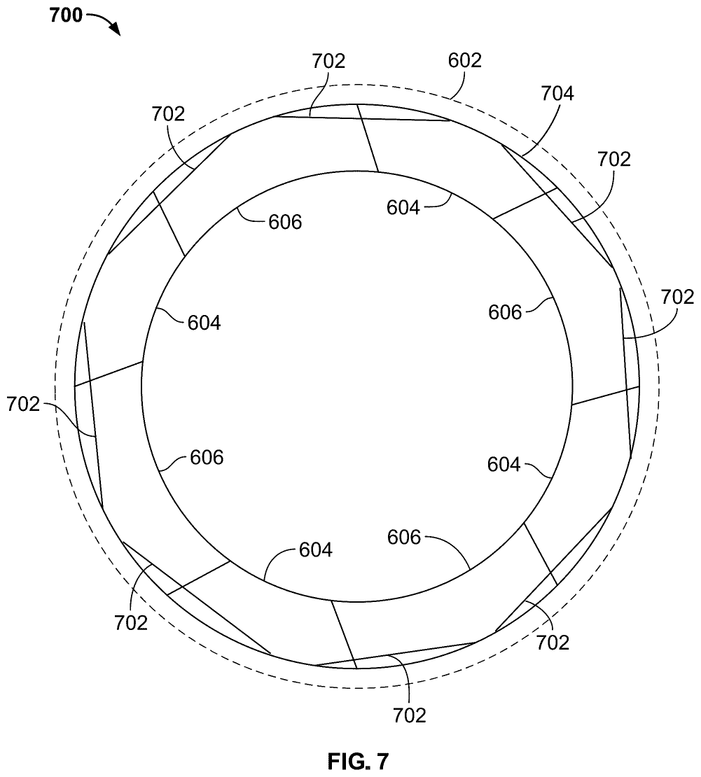

FIG. 7 depicts example sealing ring arrangement 700 with chords 702 having endpoints in contact with radially outward surface 704. Sealing ring arrangement 700 depicts a sealing ring assembly that is comprised of sealing ring segments 606 and wedge-shaped sealing ring segments 604 arranged within cylinder bore 602. The sealing ring assembly is configured to expand radially outward to contact cylinder bore 602 and form a seal based at least in part on radially outward force. The radially outward force can, in some embodiments, be generated based on a reaction in a portion of the cylinder. On either side of each of wedge-shaped sealing ring segments 604 are respective sealing ring segments 606. Chords 702 are considered to be of a circle at least partially defined by radially outward surface 704, which circumferentially extends around sealing ring arrangement 700. Each of chords 702 is, in some embodiments, a respective straight line segment with respective endpoints that lie on a circular arc (e.g., radially outward surface 704). Any of chords 702 may, in some embodiments, correspond to any of the depicted arrangements of pinned spring assemblies 206A and 206B of FIG. 2, blind holes 214A and 214B of FIG. 2, or sliding interfaces 306A or 306B of FIG. 3B. Accordingly, radially outward surface 704 may, in some embodiments, be a sealing surface that at least partially defines a circle and chords 702 of the circle defined at least partially by radially outward surface 704 may define relative positions of blind holes (e.g., blind holes 214A and 214B of FIG. 2) as the blind holes extend through at least one ring segment of the pluralities of ring segment depicted by ring segments 602 and wedge-shaped ring segments 604. The blind holes may, in some embodiments, not extend entirely along an entire length of any of chords 702. For example, the blind holes may only partially extend along a respective chord of chords 702 (e.g., as exemplified in FIGS. 2 and 3B).

FIG. 8 depicts example generator 800 including two piston assemblies that each include sealing ring assemblies, such as those illustrated in any of FIGS. 1-7, in accordance with some embodiments of the disclosure. Generator 800 including two free piston assemblies 810 and 820 that include respective sealing ring assemblies 812 and 822 in accordance with some embodiments of the present disclosure. In some embodiments, respective sealing ring assembly 812 and 822 are each configured for oil-less operation. In some embodiments, generator 800 may include linear electromagnetic machines 850 and 855 to convert between kinetic energy of respective free piston assemblies 810 and 820 and electrical energy. In some embodiments, generator 800 may include gas regions 860 and 862, which may, for example, be at a relatively lower pressure than gas region 870 (e.g., a high-pressure region) for at least some, if not most, of a cycle (e.g., an operation cycle of a generator, or an air compression cycle). For example, gas regions 860 and 862 (e.g., low pressure regions) may be open to respective breathing ducting (e.g., an intake manifold, an intake system, an exhaust manifold, an exhaust system). To illustrate, breathing ports 834 and 835 are configured to provide reactants to, and remove exhaust from, bore 832 of cylinder 830. In a further example, gas regions 860 and 862 may be vented to atmosphere (e.g., be at about 1.01 bar absolute pressure). In some embodiments, generator 800 may include gas springs 880 and 885, which may be used to store and release energy during a cycle in the form of compressed gas (e.g., a driver section). For example, free piston assemblies 810 and 820 may each include respective pistons 882 and 887, having grooves for respective sealing ring assemblies 881 and 886, to seal respective gas regions 883 and 888 (e.g., high-pressure regions) from respective gas regions 884 and 889 (e.g., low-pressure regions).

Cylinder 830 may include bore 832, centered about axis 872. In some embodiments, free piston assemblies 810 and 820 may translate along axis 872, within bore 832, allowing gas region 870 to compress and expand. For example, gas region 870 may be at relatively high pressure as compared to gas region 860 for at least some of a stroke of free piston assemblies 810 and 820 (e.g., which may translate along axis 872 in opposed piston synchronization). Sealing ring assemblies 812 and 822 may seal gas region 870 from respective gas regions 860 and 862 within bore 832. In some embodiments, free piston assemblies 810 and 820 may include respective pistons 814 and 824, and respective sealing ring assemblies 812 and 822 which may be arranged in respective corresponding grooves of pistons 814 and 824. It will be understood that gas regions 860 and 862, and gas region 870, may change volume as free piston assemblies 810 and 820 move or are otherwise positioned at different, distinct, or separate locations along axis 872. The portions of respective sealing ring assemblies 812 and 822 nearest gas region 870 are each termed the front, and the portion of sealing ring assemblies 812 and 822 nearest respective gas regions 860 and 862 are each termed the rear. Sealing ring assemblies 812 and 822 may each include a high-pressure boundary, which may each depend on a pressure in gas region 870. For example, a high-pressure boundary of sealing ring assembly 812 may be open to gas region 870 (e.g., coupled by one or more orifices, or other opening), and have a corresponding pressure the same as (e.g., if gas from gas region 870 is unthrottled in the sealing ring assembly), or less than (e.g., if gas from gas region 870 is throttled in the sealing ring assembly), the pressure of gas region 870. Sealing ring assemblies 812 and 822 may each include a low-pressure boundary, which may depend on a gas pressure in respective gas regions 860 and 862. For example, a low-pressure boundary of sealing ring assembly 812 may be open to gas region 860 and have a corresponding pressure about the same as the pressure of gas region 860. In some embodiments, as sealing ring assemblies 812 and 822 axially pass over respective ports 835 and 834 (e.g., and corresponding port bridges, although not shown), they may experience uneven, or reduced, inward force from bore 832.

In some embodiments, pistons 814 and 824 may each include one or more grooves into which one or more respective sealing ring assemblies may be arranged. For example, as shown in FIG. 8, pistons 814 and 824 may each include one groove, into which sealing ring assembly 812 and sealing ring assembly 822 may be installed, respectively. In a further example, although not shown in FIG. 8, piston 814 may include two grooves, in which two respective sealing ring assemblies may be installed. In a further example, piston 814 may include two grooves, the first sealing ring assembly 812, and the second (not shown), arranged to the rear of sealing ring assembly 812, but with its front nearer to gas region 860, thereby sealing pressure in gas region 860 to pressure between the two sealing ring assemblies (e.g., which may be less than pressure in gas region 870). Accordingly, a sealing ring assembly may be used to seal any suitable high pressure and low-pressure regions from each other.

In some embodiments, free piston assemblies 810 and 820 may include respective magnet sections 851 and 856, which interact with respective stators 852 and 857 to form respective linear electromagnetic machines 850 and 855. For example, as free piston assembly 810 translates along axis 872 (e.g., during a stroke of an operation cycle of a generator), magnet section 851 may induce current in windings of stator 852. Further, current may be supplied to respective phase windings of stator 852 to generate an electromagnetic force on free piston assembly 810 (e.g., to effect motion of free piston assembly 810).

In some embodiments, pistons 814 and 824, sealing ring assemblies 812 and 822, and cylinder 830 may be considered a piston and cylinder assembly. In some embodiments, generator 800 may be an engine, an air compressor, any other suitable device having a piston and cylinder assembly, or any combination thereof. In some embodiments, generator 800 need not include two free piston assemblies. For example, cylinder 830 could be closed (e.g., with a cylinder head), and free piston assembly 810 alone may translate along axis 872.

It is noted that any multi-part reference numerals may be collectively referenced by the shared reference numeral. It is further noted that certain elements may appear multiple times within a single figure. For clarity of illustration, each instance of such elements may not be explicitly labeled with a reference numeral. As will be understood by one of ordinary skill in the art, such unlabeled instances are not necessarily different from the corresponding labeled instances due to lacking a reference numeral. Additionally, they are also not necessarily the same.

It will be understood that the present disclosure is not limited to the embodiments described herein and can be implemented in the context of any suitable system. In some suitable embodiments, the present disclosure is applicable to reciprocating generators and compressors. In some embodiments, the present disclosure is applicable to generators and compressors. In some embodiments, the present disclosure is applicable to reaction devices such as a reciprocating generator and a generator. A reaction device is inclusive of reaction related devices. A reaction, as used herein, is inclusive of both non-combustion reactions and combustion reactions. In some embodiments, the present disclosure is applicable to non-combustion and non-reaction devices such as reciprocating compressors and compressors. In some embodiments, the present disclosure is applicable to gas springs. In some embodiments, the present disclosure is applicable to oil-free reciprocating generators and compressors. In some embodiments, the present disclosure is applicable to oil-free generators with internal or external reactions. In some embodiments, the present disclosure is applicable to oil-free generators that operate with compression ignition (e.g., homogeneous charge compression ignition, stratified charge compression ignition, or other compression ignition), spark ignition, or both. In some embodiments, the present disclosure is applicable to oil-free generators that operate with gaseous fuels, liquid fuels, or both. As used herein, the term “fuel” refers to matter that reacts (e.g., with an oxidizer). Suitable fuels for use with any or all of the systems, assemblies, or components of this disclosure include common gaseous alkanes or alkenes (e.g., methane, ethane, propane, ethylene, propene), alcohols (methanol, ethanol, propanol), hydrocarbon fuels (e.g., one or more of natural gas, biogas, gasoline, diesel, biodiesel, propane, or ethane), non-hydrocarbon fuels (e.g., one or more of hydrogen or ammonia), alcohol fuels (e.g., one or more of ethanol, methanol, or butanol) or any mixtures of any of the aforementioned fuels. The generators described herein are suitable for both stationary power generation and portable power generation (e.g., for one or more of power grid powering or vehicle propulsion, or vehicle on-board power generation such as for battery charging). In some embodiments, the present disclosure is applicable to linear generators. In some embodiments, the present disclosure is applicable to generators that can be reaction generators with internal reaction or any type of heat generator with external heat addition (e.g., from a heat source or external reaction). In some embodiments, the present disclosure is applicable to closed cycle linear generators having a burner for reacting a fuel to generate heat for the closed cycle linear generator (e.g., closed cycle free-piston heat engine). Additionally, or alternatively, a closed cycle free piston linear generator or a closed cycle free piston heat engine can be considered suitable architecture for integrating into or incorporating any or all of the systems, assemblies, or subcomponents thereof of this disclosure.

The terms “linear generator”, “linear generator system”, and “linear generator assembly” are generally used interchangeably in the present disclosure to refer to an arrangement and configuration of components that include at least one LEM (i.e., one or more translators and one or more stators) as well as other components for the generation of power by way of the linear movement of a translator relative to a stator. The other components may include any suitable one or more ports, valves, housings, control systems, power cylinders, any other one or more suitable auxiliary systems or components, or any combination thereof. In some embodiments, any of a linear generator, linear generator system, or linear generator assembly may include one or more batteries. In some embodiments, batteries may be exclusive of any of a linear generator, linear generator system, or linear generator assembly. These terms may sometimes take on meanings based on the context in which they are used in this disclosure. For example, a linear generator system may be described in portions of this disclosure as including one or more linear generators (e.g., in addition to other components apart from the one or more linear generators). In this case, the term “linear generator system” takes on a distinct meaning relative to a “linear generator.” It will be understood that a linear generator system or a linear generator may include one or more constituent linear generator systems and linear generators, respectively.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the claims.

1.-20. (canceled)

21. A sealing ring assembly comprising:
at least one flexure; and
a plurality of ring segments, wherein:
at least one ring segment of the plurality of ring segments comprises:
a radially outward sealing surface that at least partially defines a circle, and
a blind hole extending along a chord of the circle;
a flexure of the at least one flexure is arranged in the blind hole; and
the at least one flexure interfaces with at least one other ring segment of the plurality of ring segments that is adjacent to the at least one ring segment.

22. The sealing ring assembly of claim 21, wherein the respective flexure generates a respective force along the respective chord.

23. The sealing ring assembly of claim 22, wherein the respective force comprises 1) a radially outward force to cause a respective radially outward surface of respective pairs of adjacent ring segments of the plurality of ring segments to seal against a bore of a cylinder, and 2) a tangential force to be applied on the sealing ring assembly.

24. The sealing ring assembly of claim 21, wherein the at least one ring segment comprises a wedge shape.

25. The sealing ring assembly of claim 21, wherein the at least one other ring segment comprises a notch that accommodates a portion of at least one of the at least one flexure or at least one flexure assembly.

26. The sealing ring assembly of claim 21, wherein the at least one flexure comprises a spring.

27. The sealing ring assembly of claim 26, wherein the spring comprises a coiled spring.

28. The sealing ring assembly of claim 27, further comprising a pin arranged along a length of the coiled spring.

29. The sealing ring assembly of claim 28, wherein the pin comprises a rounded head for engaging the pin with a notch of the at least one other ring segment.

30. The sealing ring assembly of claim 21, wherein an opening of the blind hole is offset toward an axial end of the at least one ring segment.

31. The sealing ring assembly of claim 21, wherein the blind hole extends into the at least one ring segment parallel to a surface profile of a wedge shaped surface of the at least one other ring segment.

32. A device comprising:
a cylinder comprising a bore; and
a sealing ring assembly comprising:
at least one flexure; and
a plurality of ring segments, wherein:
at least one ring segment of the plurality of ring segments comprises:
a radially outward sealing surface that at least partially defines a circle, and
a blind hole extending along a chord of the circle;
a flexure of the at least one flexure is arranged in the blind hole; and
the at least one flexure interfaces with at least one other ring segment of the plurality of ring segments that is adjacent to the at least one ring segment.

33. The device of claim 32, wherein the respective flexure generates a respective force along the respective chord.

34. The device of claim 33, wherein the respective force comprises 1) a radially outward force to cause a respective radially outward surface of respective pairs of adjacent ring segments of the plurality of ring segments to seal against a bore of a cylinder, and 2) a tangential force to be applied on the sealing ring assembly.

35. The device of claim 32, wherein the at least one ring segment comprises a wedge shape.

36. The device of claim 32, wherein the at least one other ring segment comprises a notch that accommodates a portion of at least one of the at least one flexure or at least one flexure assembly.

37. The device of claim 32, wherein the at least one flexure comprises a spring.

38. The device of claim 37, further comprising a pin arranged along a length of the spring, wherein the pin a rounded head for aligning the pin with a notch of the at least one other ring segment.

39. The device of claim 32, wherein:
an opening of the blind hole is offset toward an axial end of the at least one ring segment; and
the opening is closer to a radially inward external surface of the at least one ring segment than a radially outward external surface of the at least one ring segment.

40. The sealing ring assembly of claim 32, wherein the blind hole extends into the at least one ring segment parallel to a surface profile of a wedge shaped surface of the at least one other ring segment.

41. (canceled)
